(19) United States
(12) Patent Application Publication
(10) Pub. No.: US 2006/0157391 A1
(43) Pub. Date: Jul. 20, 2006

(54) System for monitoring the performance of fluid treatment cartridges

(76) Inventors: Robert E. Astle, Middlefield, CT (US); Hemang Patel, West Haven, CT (US); Mahesh Patel, Plantsville, CT (US); Thomas Holler, Glastonbury, CT (US)

Correspondence Address: 3M INNOVATIVE PROPERTIES COMPANY, PO BOX 33427, ST. PAUL, MN, 55133-3427, US

(21) Appl. No.: 11/386,012

(22) Filed: Mar. 20, 2006

Related U.S. Application Data
(63) Continuation of application No. 10/367,083, filed on Feb. 14, 2003, now abandoned.
(60) Provisional application No. 60/357,180, filed on Feb. 15, 2002.

(51) Int. Cl. B01D 35/143

(52) U.S. Cl. 210/85; 210/91; 96/417

(57) ABSTRACT

A fluid treatment system is disclosed that includes a replaceable and/or serviceable fluid treatment cartridge for treating fluid passing therethrough, and a connector head configured to detachably support the fluid treatment cartridge. The cartridge includes a device for storing data related to the performance and/or identity of the cartridge, and a mechanism is provided to facilitate an exchange of data between the fluid treatment cartridge and a monitoring device configured to process the data.

### CROSS-REFERENCE TO RELATED APPLICATIONS

This application is a continuation of U.S. patent application Ser. No. 10/367,083, filed on Feb. 14, 2003, which claims the benefit of priority to U.S. Provisional Patent Application Ser. No. 60/357,180 filed Feb. 15, 2002, the disclosure of each is incorporated herein by reference to the extent not inconsistent with the present application.

### BACKGROUND OF THE INVENTION

1. Field of the Invention

The subject invention is directed to fluid treatment systems and more particularly, to a system for monitoring the performance of replaceable and/or serviceable fluid treatment cartridges.

2. Background of the Related Art

Replaceable and/or serviceable fluid treatment devices such as filter cartridge, additive dispensers and the like are well known in the art and have been utilized for many years in residential and commercial fluid treatment systems. For the most part, the life of a fluid treatment cartridge is limited. For example, the life of a filter cartridge is limited by its contaminant holding capacity, while the life of an additive dispenser is limited by the amount of additive contained therein. In general, it is difficult for a user to know or to determine when a fluid treatment cartridge has exceeded its useful life and should therefore be removed, replaced and discarded, or in the case of a serviceable fluid treatment cartridge, when the cartridge should be backwashed, cleaned or regenerated.

One effort to resolve this problem is disclosed in U.S. Pat. No. 6,024,867 to Parise which presents a counter top filter unit with a replaceable electronic display monitor mounted within the housing that supports the filter cartridge. The life span of the filter cartridge is shown on the display monitor in terms of colored indicator lights which denote whether the filter cartridge in within, nearing or outside its expected life span. The display monitor is electronically linked with associated flow monitoring components and a microprocessor for establishing the amount of water purified by the filter and for interpreting that amount in terms of the life span of the filter cartridge. While this system provides advantages over unmonitored filtration systems, the monitoring device must be replaced each time a new filter is employed. In other words, the monitoring system is not designed to be reset after a spent cartridge is removed.

In most instances, the replaceable and/or serviceable fluid treatment devices employed in commercial and consumer appliances are manufactured in accordance with particular design specifications and performance parameters provided by the appliance manufacturer. In many cases, the filter media used in such filters consists of a proprietary material or is manufactured using a proprietary process. Thus, appliance manufactures often recommend that replacement cartridges be purchased from the original equipment provider so as to ensure the integrity and proper operation of the filtering system.

Oftentimes, the owner of a household appliance or the maintenance personnel servicing a commercial vending machine is not aware of the replacement filter specifications and operating parameters of the filtering system. Consequently, they unknowingly jeopardize the integrity of the filtration system by replacing a used filter with an inferior or incompatible replacement filter supplied by an after-market manufacturer. This problem has also been encountered by automotive filter manufacturers, as inferior replacement fuel filters are frequently installed in a vehicle without the knowledge of the vehicle owner or operator.

It would be beneficial to provide a system for monitoring the performance of a replaceable and/or serviceable fluid treatment cartridge that is configured to be reset upon cartridge replacement and/or servicing and is adapted to prevent the use of unauthorized or incompatible replacement cartridges.

### SUMMARY OF THE INVENTION

The subject invention is directed to a new and useful fluid treatment system that includes a unique replaceable and/or serviceable fluid treatment cartridge and a connector head configured to detachably support the cartridge. The fluid treatment cartridge includes means for storing data and/or the identity of the fluid treatment cartridge and means for facilitating an exchange of data between the fluid treatment cartridge and a cartridge monitoring device. The system further includes a cartridge monitoring device adapted and configured to receive and process data and/or information from the fluid treatment cartridge.

In one embodiment of the subject invention, the data storing means of the cartridge is a dynamic data storage device, such as an electronic memory storage device, which stores at least cartridge performance set points. The set points include, for example, pressure drop set points, flow rate set points, capacity set points and longevity (time in service) set points. Examples of electronic programmable memory devices that can be used in or on the cartridge as a dynamic storage device are RAM (random access memory), ROM (read-only memory), PROM (programmable read-only memory), EPROM (erasable programmable read-only memory), EEPROM (electronically programmable read-only memory) and flash memory.

In accordance with a preferred embodiment of the subject invention, sensing means are provided for measuring cartridge performance parameters such as, for example, the pressure drop across the cartridge and/or the flow rate of fluid through the cartridge. Depending upon the type of sensing means employed in the system, the sensing means may be associated with either one or both of the inlet flow path and/or the outlet flow path of the connector head. The subject invention further includes means for monitoring the cartridge performance parameters received from the sensing means, as well as means for comparing the cartridge performance parameters received from the sensing means with the cartridge set point data stored in the dynamic data storage device of the fluid treatment cartridge to determine whether a stored cartridge set point has been exceeded.

Means are operatively associated with at least one of the fluid treatment cartridge and the connector head for preventing fluid flow through the fluid treatment cartridge after a cartridge set point has been exceeded. Such means can take the form of an electronically controlled valving member or a similar flow control device. In addition to or as an alternative to the flow preventing means, the monitoring means has means associated therewith for indicating that a cartridge set point has been exceeded, for example, an alarm, signal lamp or message display screen can be employed.

In another embodiment of the subject invention, the data storing means of the cartridge is a static data storage device which stores at least the identity of the fluid treatment cartridge. In such an instance, the means for facilitating an exchange of data between the fluid treatment cartridge and a cartridge monitoring device includes a device mounted in the connector head for receiving data from the static data storage device. In addition, there is means in communication with the connector head for processing the identification data stored in the static data storage device of the fluid treatment cartridge and received by the data reception device in the connector head to determine the identity of the fluid treatment cartridge.

The subject invention further includes means in communication with the connector head for processing the cartridge identification data stored in the static data storage device to determine the identity of the fluid treatment cartridge, and means are provided for accessing electronically stored cartridge set point data based on the identity of the fluid treatment cartridge. In this instance, the set point data can be stored in a monitoring device associated with the connector head, or at a remote location in communication with the connector head. It is envisioned that the static data storage device can take the form of a device configured to emit a magnetic signature identifying the fluid treatment cartridge or a device configured to present a graphical symbol, such as a bar code, identifying the fluid treatment cartridge. Accordingly, the means for receiving the identification data would take the form of a device for responding to a magnetic signature reading or a device for reading a bar code, which are well known in the art.

The subject invention is also directed to a fluid treatment system that includes a fluid treatment cartridge, and monitoring means electrically connected to the fluid treatment cartridge for monitoring data relating to cartridge performance. The monitoring means includes means for storing cartridge performance set point data, means for receiving cartridge performance data, and means for comparing the cartridge performance data to the performance set point data to determine whether a performance set point has been exceeded. In addition, the system includes means for terminating the electrical connection between the fluid treatment cartridge and the monitoring means when a performance set point has been exceeded, so as to encourage replacement of the fluid treatment cartridge. Preferably, the means for terminating the electrical connection between the fluid treatment cartridge and the monitoring means is a conventional fuse.

The subject invention is also directed to a fluid treatment cartridge that includes a cartridge housing defining an interior chamber containing a fluid treatment device for treating fluid passing therethrough, an inlet through which untreated fluid enters the interior chamber of the housing and an outlet from which treated fluid exits the interior chamber of the cartridge housing, and means associated with the cartridge housing for storing data relating to the fluid treatment cartridge. The means for storing data relating to the fluid treatment cartridge can be a dynamic data storage device or a static data storage device, and the means for storing data includes data relating to cartridge performance, data relating to cartridge identification, data relating to cartridge specifications, data relating to product offerings or similar forms of information.

### BRIEF DESCRIPTION OF THE DRAWINGS

So that those having ordinary skill in the art to which the subject invention appertains will more readily understand how to construct and use the system for monitoring the performance of replaceable and/or serviceable fluid treatment cartridges of the subject invention, reference may be had to the drawings wherein:

FIG. 1 is a perspective view of a system for monitoring the performance of a fluid treatment cartridge constructed in accordance with a preferred embodiment of the subject invention which includes a monitoring device for communicating with a fluid treatment cartridge configured to store data relating to cartridge performance, wherein the monitoring device includes, among other things, a display panel for conveying information relating to the performance of the cartridge;

FIGS. 2 through 4 are exemplary display panel screens used by the monitoring device to convey information relating to the performance of the cartridge performance, including a message page, a deactivated page and a homepage;

FIG. 5 is a top plan view of the upper end of the fluid treatment cartridge illustrated in FIG. 1 which includes a powered circuit board containing an electronic device adapted to store data relating to cartridge performance;

FIG. 6 is an exploded perspective view of the upper end portion of the fluid treatment cartridge illustrated in FIG. 1 with the printed circuit board separated from the cartridge for ease of illustration;

FIG. 7 is a perspective view from below of a section of the connector head shown in FIG. 1 illustrating a pair of contact pins for communicating with the printed circuit board provided on the upper end of the fluid treatment cartridge;

FIG. 8 is a perspective view as in FIG. 7, with the contact pin mounting plate separated from the connector head for ease of illustration;

FIG. 9 is a side elevational view of the monitoring system of the subject invention showing the fluid treatment cartridge detachably engaged with the connector head, with a portion of the connector head broken away to illustrate engagement between the contact pins and the contact pads on the printed circuit board;

FIG. 10 is perspective view of another version of a system for monitoring the performance of a fluid treatment cartridge wherein the cartridge includes a circuit containing a conventional fuse which is electrically connected to a controller, wherein the fuse remains intact when the cartridge is operating within preset parameters recognized by the controller;

FIG. 11 is a perspective view as in FIG. 10, wherein the fuse is burned by a surge provided by the controller in response to a preset cartridge operating parameter having been exceeded, and wherein an alarm is sounded as a result thereof;

FIG. 12 is a top plan view of the upper portion of a fluid treatment cartridge constructed in accordance with a preferred embodiment of the subject invention which includes graphical bar code for communicating with corresponding bar code readers disposed in the connector head;

FIG. 13 is a side elevational view of the fluid treatment cartridge of FIG. 12 detachably engaged with a connector head containing bar code readers for identifying the cartridge by way of its bar code signature;

FIG. 14 is a top plan view of the upper portion of a fluid treatment cartridge constructed in accordance with a preferred embodiment of the subject invention which includes magnetic signature generating devices for communicating with corresponding reed switches disposed in the connector head;

FIG. 15 is a side elevational view of the fluid treatment cartridge of FIG. 14 detachably engaged with a connector head containing reed switches for identifying the cartridge by way of its magnetic signature;

FIG. 16 is a side elevational view of a fluid treatment system constructed in accordance with a preferred embodiment of the subject invention wherein a valve member connected to a monitoring device is disposed within the flow path in the connector head to prevent the flow of fluid into the fluid treatment cartridge when a set point has been exceeded;

FIG. 17 is a side elevational view of a fluid treatment system constructed in accordance with a preferred embodiment of the subject invention wherein a valve member connected to a monitoring device is disposed within the flow path of the cartridge to prevent the flow of fluid therethrough when a set point has been exceeded;

FIG. 18 is a side elevational view in partial cross-section of the lower end portion of a fluid treatment cartridge for use with the monitoring system of the subject invention in the form of an additive dispensing apparatus;

FIG. 19 is a side elevational view in partial cross-section of the lower end portion of a fluid treatment cartridge for use with the monitoring system of the subject invention in the form of a filtering device; and

FIG. 20 is an illustration of a system for remotely monitoring the performance of a replaceable fluid treatment cartridge, wherein the system is configured to facilitate wireless communication with the connector head so as to download and upload data relating to the performance of the fluid treatment cartridge associated therewith.

These and other features of the fluid treatment system of the subject invention will become more readily apparent to those having ordinary skill in the art from the following detailed description of the preferred embodiments.

### DETAILED DESCRIPTION OF THE PREFERRED EMBODIMENTS

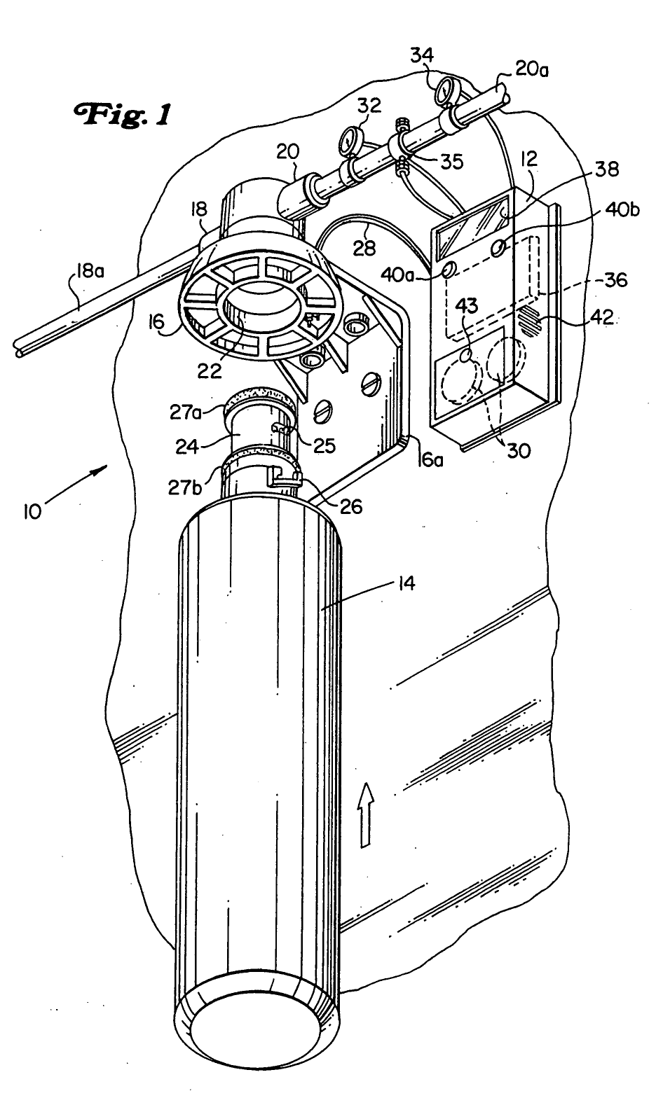

Referring now to the drawings wherein like reference numerals identify similar structural elements and/or features of the subject invention, there is illustrated in FIG. 1 a system for monitoring the performance of a replaceable and/or serviceable fluid treatment cartridge constructed in accordance with a preferred embodiment of the subject invention and is designated generally by reference numeral 10. This system monitors the performance of a replaceable fluid treatment cartridge, such as a filter, coalecser, or additive dispenser or a serviceable fluid treatment cartridge such as a backwashable, regenerative or cleanable cartridge or a similar device to determine whether the cartridge is operating within predefined performance parameters or more importantly, whether the cartridge has exceeded one or more predefined performance set points and is therefore due for replacement. The system may also be adapted to maintain the integrity of a fluid treatment process by preventing the use of an unauthorized or incompatible cartridge, such as a cartridge manufactured by an unauthorized after-market supplier.

In general, system 10 includes an electronic monitoring device 12 for communicating, either directly or indirectly, with a fluid treatment cartridge 14 configured to store data such as cartridge performance data, cartridge identification data, cartridge specification data or even product advertising information. It is envisioned that cartridge performance data, such as performance set points relating to the pressure drop across the cartridge, the flow rate through the cartridge, or the time the cartridge has been in service can be stored on or in the cartridge either by way of a static data storage device (e.g., a bar code) or a dynamic data storage device (e.g., an electronic programmable memory storage device) to be discussed in more detail hereinbelow. It is also envisioned that cartridge identification data such as the identity of the cartridge manufacturer can be stored on or in the cartridge by way of a static or dynamic data storage means so as to permit the use of compatible and/or authorized cartridge while preventing the use of an unauthorized or incompatible cartridge.

It is envisioned that the monitoring device 12 will continuously decrement the remaining life of the cartridge based upon the stored set points, and in the case of a dynamic memory storage device, it is envisioned that the decremented values will be stored in the data storage device of the cartridge so that the temporary removal of the cartridge from the system would not effect the integrity of the monitoring system.

As illustrated in FIG. 1, cartridge 14 is adapted and configured to interact with, communicate with and otherwise detachably interconnect with a connector head 16 that is in direct communication with a source of treatable fluid, such as, for example, a source of untreated drinking water. More particularly, connector head 16 has an inlet portion 18 for communicating with a fluid supply line 18a and an outlet portion 20 for communicating with a fluid outlet conduit 20a. Connector head 16 further defines an axial bore 22 for operatively receiving the upper neck portion 24 of cartridge 14. Neck portion 24 is provided with radial inlet ports 25a bounded by upper and lower o-ring seals 27a, 27b for communicating with the inlet portion 18 of connector head 16, and an axial outlet port 25b (see FIG. 6) for communicating with the outlet portion 20 of connector head 16. The inlet ports 25a in neck portion 24 allow untreated fluid to enter the interior chamber of fluid treatment cartridge 14 from the fluid supply line 18a by way of inlet portion 18, and the outlet port 25b permits treated fluid to exit the interior chamber of fluid treatment cartridge 14 into the fluid outlet conduit 20a by way of outlet portion 20. Connector head 16 is also optionally provided with an integral generally L-shaped mounting bracket 16a for securement to a supporting structure such as a wall.

With continuing reference to FIG. 1, keyed camming lugs 26 are operatively associated with the lower portion of neck portion 24 to interact and mate with corresponding keyed recesses (not shown) that are formed within the axial bore 22 of connector head 16 to ensure cartridge compatibility, that is to prevent engagement with an incompatible cartridge. A similar keyed lockout system is disclosed in commonly assigned U.S. Pat. No. 6,458,269 to Bassett et al., the disclosure of which is herein incorporated by reference in its entirety. It is envisioned and well within the scope of the subject disclosure that a keyed camming lug such as that shown in FIG. 3 and described in the Bassett et al. patent could operate as a static memory device in conformance with the objectives of the subject invention, whereby the monitoring device would recognize a particular key configuration as a signature or identifying feature of a specific type or model of fluid treatment cartridge (e.g., a cartridge from a particular manufacturer), and would attribute certain operating parameters to that cartridge.

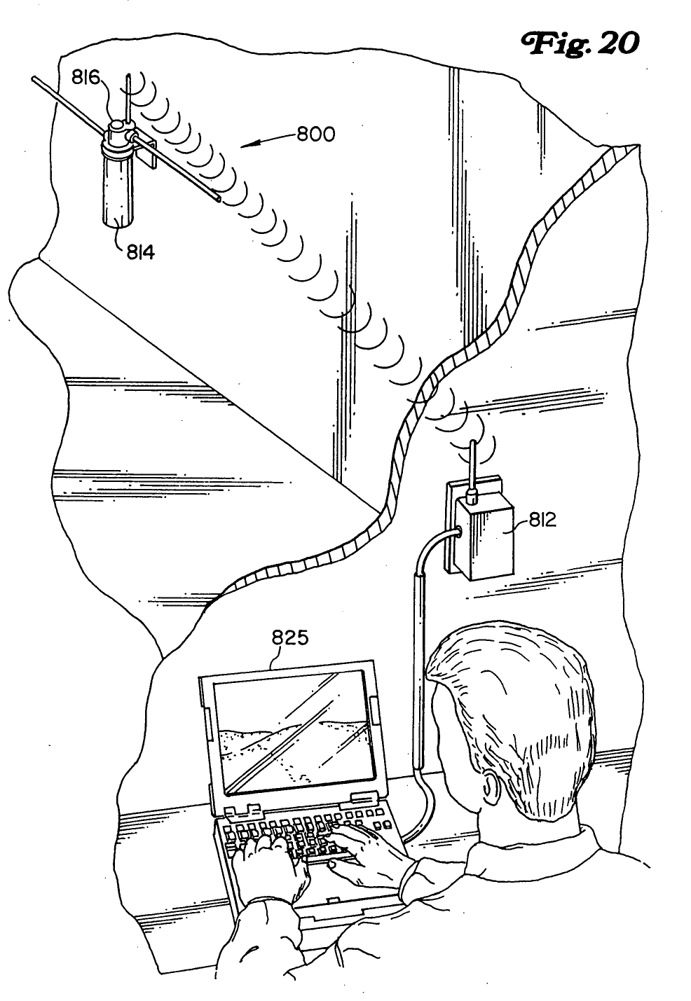

As illustrated in FIG. 1, monitoring device 12 communicates with the connector head 16 by way of a hard-wired connection 28. Alternatively, as illustrated in FIG. 20, which will be discussed in more detail hereinbelow, connector head 16 can communicate with a monitoring station by way of a wireless connection. The monitoring device 12 can contain an on-board power supply such as batteries 30, which can serve as a primary power source or as an auxiliary power supply in case of a loss of external power. The monitoring device 12 communicates with a plurality of sensors operatively associated with the inlet and/or outlet conduits that communicate with the connector head 16 and cartridge 14. These sensors include, for example, a pressure transducer 32 for measuring the pressure drop across fluid treatment cartridge 14 and a flow meter 34 for measuring the flow rate through cartridge 14.

Monitoring device 12 is preferably controlled by a microprocessor 36 that coordinates communication between the cartridge 14 and the monitoring device 12, and processes cartridge performance data received from a memory storage device of cartridge 14 as well as from the sensors 32 and 34. It is envisioned that microprocessor 36 would be integrated with a dip-switch (not shown) for selecting between a plurality of flow rate values (e.g., 0.5 gpm, 0.75 gpm, 1 gpm and 1.5 gpm) depending upon the designated flow rate set point of the particular cartridge being employed in the fluid treatment system. The microprocessor 36 preferably includes an integrated timing circuit for measuring the useful life of cartridge 14. The timing circuit may be triggered when the cartridge 14 initially engages connector head 16 or the timing circuit may cooperate with a flow sensor or similar device so that the timer is incremented only when fluid is flowing through the cartridge.

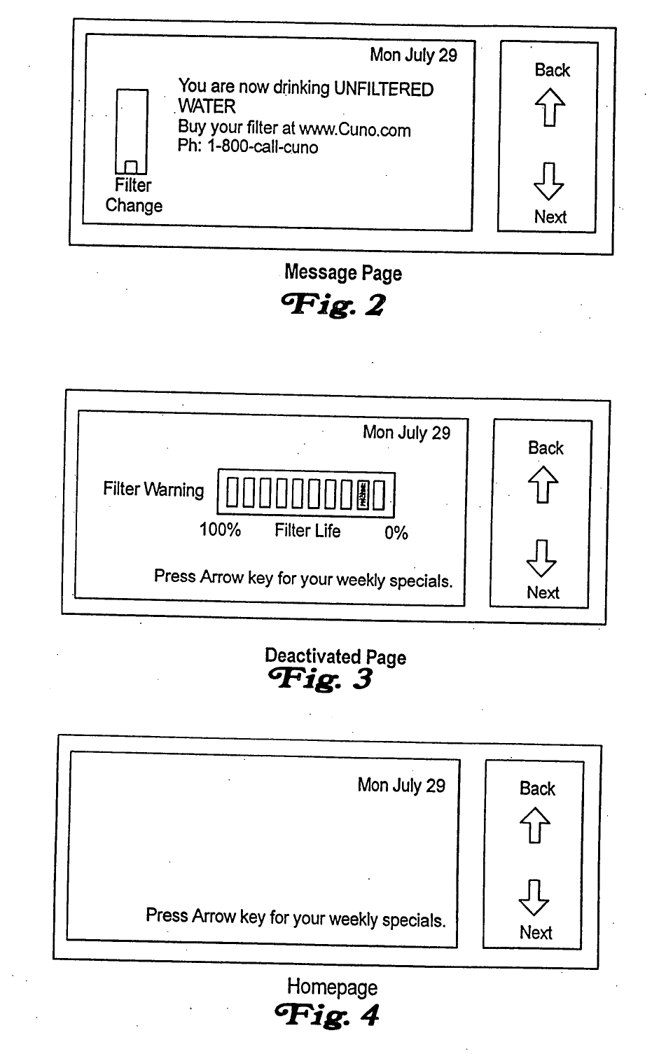

Monitoring device 12 further includes a display panel, such as a liquid crystal display panel 38, connected to microprocessor 36 for presenting information to an observer concerning the operating parameters of a cartridge, such as the warning shown on the sample display page of FIG. 2, or the graphics showing the life expectancy of the cartridge on the sample page of FIG. 3. It is also envisioned that the display panel 38 can present product specifications, product advertisements, manufacturer coupons, informational messages about a product or new product offerings such as for example weekly specials as offered on the sample page shown in FIG. 4. This data could be supplied to the monitoring device 12 through an up-link with the internet or world wide web, as illustrated for example in FIG. 20, or the information can be stored by the cartridge manufacturer in a preprogrammed on-board memory storage device.

With continuing reference to FIG. 1, monitoring device 12 further includes indicator lamps or diodes connected to the microprocessor 36 to provide a visual indication to an observer of the operating condition of a cartridge. For example, a green lamp or diode 40a is provided and will be illuminated when the cartridge 14 is operating within its operating limits. A red lamp or diode 40b is provided and will be illuminated when a cartridge 14 has exceeded one or more operating limits or performance set points. A speaker 42 is also provided and is connected to the microprocessor 36 to sound an alarm when a cartridge operating parameter or set point has been exceeded. The alarm may be sounded periodically or continuously. Monitoring device 12 includes a reset button 43 that turns the alarm off only for a predefined time period, for example two days, after which time the alarm will sound again until the spent cartridge is removed and replaced.

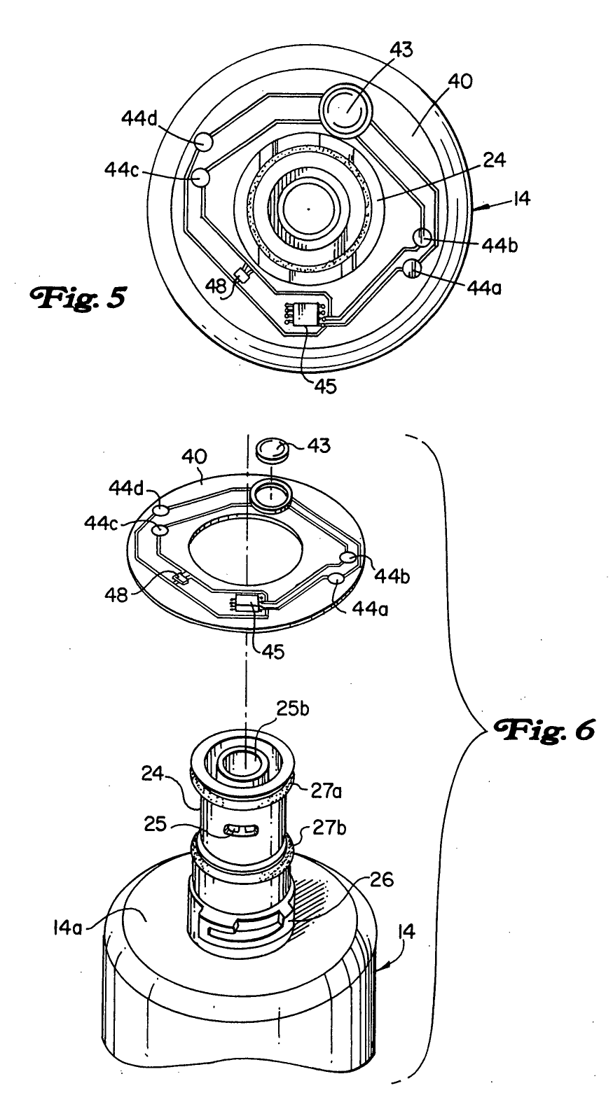

Referring now to FIGS. 5 and 6 in conjunction with FIG. 1, there is illustrated a printed circuit board 40 operatively associated with the upper end surface 14a of the fluid treatment cartridge 14. Printed circuit board 40 includes a dynamic memory storage device 45 in the form of a electronic programmable memory chip (EEPROM). Commercially available EEPROM can store up to 2 Mb of data. As noted above, the memory chip can be programmed to store performance set points and can be adapted to receive information from the monitoring system in the form of updated cartridge performance data derived by sensors 32, 34. This information transfer can occur periodically, or in near real time. Preferably, a power cell or battery 43 is supported on circuit board 40 to provide power to the memory chip 45.

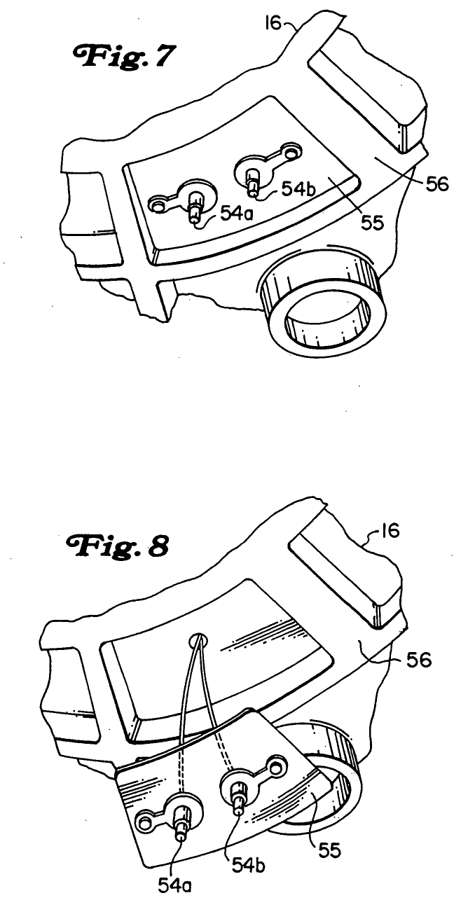

Diametrically opposed paired contact pads 44a, 44b and 44c, 44d are defined on circuit board 40 for cooperatively interacting with paired contact pins 54a, 54b supported on a mounting plate 55 on the undersurface 56 of connector head 16 shown in FIGS. 7 and 8. By providing two pairs of contact pads on circuit board 40, the user does not have to be concerned with the proper alignment of the cartridge 14 prior to installation in the connector head 16.

It is envisioned that circuit board 40 could include an embedded microprocessor (see for example electronic component 48) which is programmed to compare cartridge performance data received from the monitoring device 12 with the performance set points stored on the memory chip 45, to calculate the remaining life of cartridge 14. If a set point is exceeded, the on-board microprocessor 48 would communicate the circumstance to the monitoring device 12, whereupon an alarm could be sounded through speaker 42, a red indicator lamp 40b could be illuminated, or a message could be displayed on panel 38. For example, if the cartridge is in the form of a potable water filtration device, a message could be displayed in the manner presented in FIG. 2, which informs an observer that they are drinking unfiltered water.

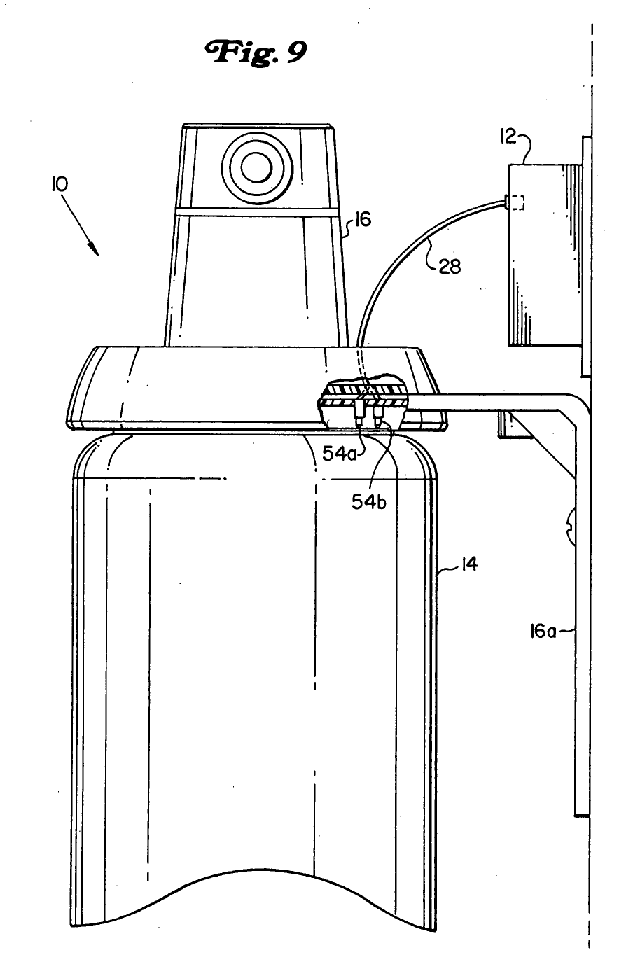

Referring to FIG. 9 in conjunction with FIG. 1, when the neck portion 24 of fluid treatment cartridge 14 is securely engaged and installed within the axial bore 22 of connector head 16, contact pins 54a, 54b are in electrical contact with one pair of contact pads (e.g., pads 44a, 44b) and a communication link is created between cartridge 14 and monitoring device 12, to facilitate the exchange of information and data therebetween. Once the communication link is established, cartridge performance data, such as performance set points or related information, can be uploaded to the monitoring device 12 from the dynamic memory storage device 45 of cartridge 14. These set points will then be utilized by the monitoring device 12 for comparison against measured performance data received from the pressure and flow sensors 32 and 34 to determine when the cartridge 14 is to be removed, discarded and replaced with a new cartridge.

By way of example, the pressure transducer 32 will monitor the pressure drop across the cartridge 14 periodically, for example, every ten minutes. When the pressure drop across the cartridge increases above a set point (e.g., 20 psi), a count value will be stored in temporary memory. The monitoring device 12 will continue to store count values for consecutive high pressure drop readings. If monitoring device 12 detects high pressure drops for three consecutive readings, action will be taken in the form of an alarm, red indicator lamp or message display to inform an observer that a performance set point has been exceeded. Other control logic arrangements are possible, including for example, control logic that stores count values after non-consecutive high pressure drop readings.

By way of another example, a flow switch 34 in the form of a reed switch could communicate with monitoring device 12. If the reed switch is in an open position, there is no fluid flowing through cartridge 14. If the switch is closed, then fluid is flowing through cartridge 14 and monitor 12 processes the data by multiplying the time of flow with a preset flow rate (set by a dip switch) to obtain a value for the volume of flow through the cartridge (gallons). It is envisioned that this value can be stored in the monitoring device, at a remote location or periodically downloaded to the memory chip 45 on cartridge 14 for storage. Once monitoring device 12 determines through computations that the set point for flow through the cartridge has been exceeded, action will be taken in the form of an alarm, red indicator lamp or message display to inform an observer of that occurrence. Instead of or in addition to the flow switch 34, a turbine style flow meter (a frequency pulse meter) 35 can be employed to provide input to the monitoring device 12. This type of sensor is configured to count a number of pulses and multiply that number by a preset gain to determine the volume of flow through cartridge 14.

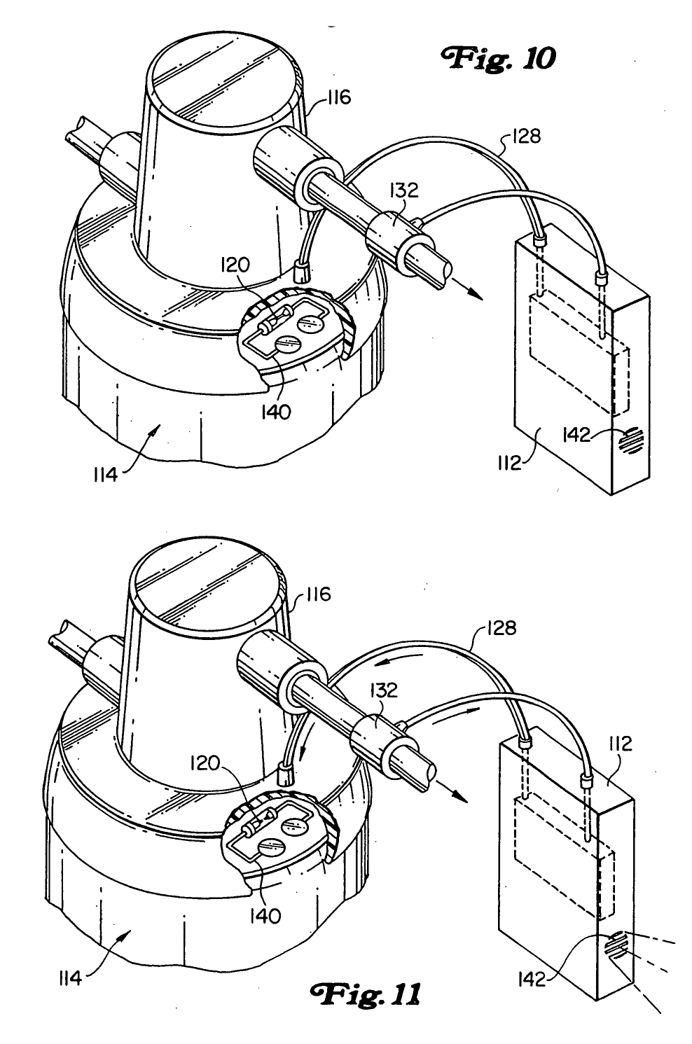

Referring now to FIGS. 10 and 11, there is illustrated another fluid treatment cartridge 114 constructed in accordance with a preferred embodiment of the subject invention which includes an integrated circuit 140 containing a conventional fuse 120 that is in electrical communication with monitoring device 112 through connector head 116 by way of wire 128. The monitoring device 112 receives data from a sensor, for example a pressure or flow sensor 132, and compares that data with stored performance data relating to cartridge 114. When a performance set point has been exceeded by a measured or sensed operating parameter, the monitoring device 112 will send a surge to the cartridge circuit 140 to burn the fuse 120. Once fuse 120 has burned, the circuit 140 will be open and an alarm 142 will sound or a similar action will be taken to inform an attendant that a set point has been exceeded and the cartridge should be removed, discarded and replaced.

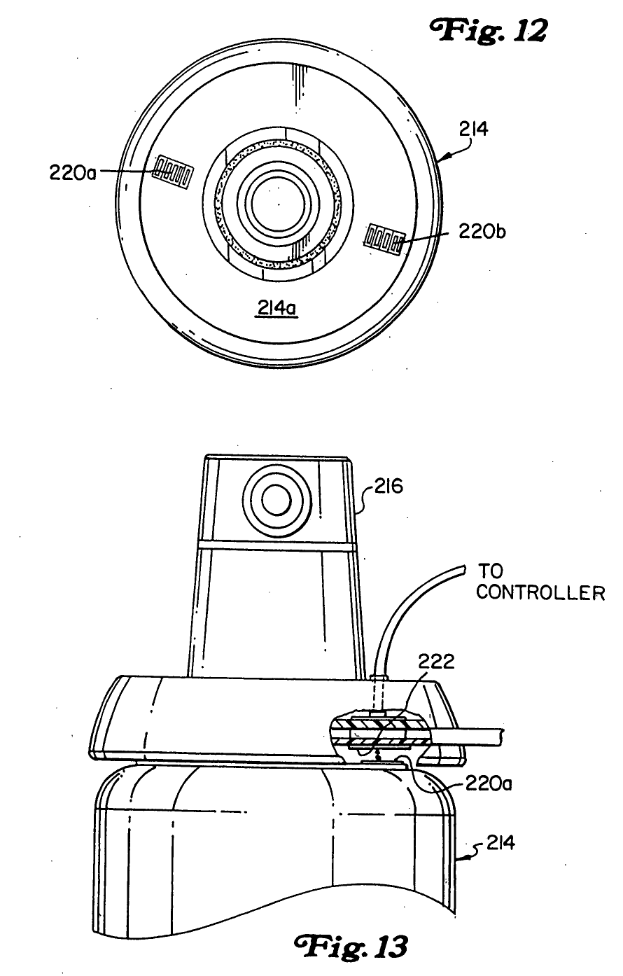

Referring to FIGS. 12 and 13, there is illustrated another fluid treatment cartridge 214 constructed in accordance with a preferred embodiment of the subject invention which includes a static memory storage device in the form of diametrically opposed graphical bar code 220a, 220b. The bar codes present cartridge performance set point data and are positioned on the upper surface 214a of cartridge 214 to interact with a bar code scanner 222 mounted on the under surface of the connector head 216. The scanner 222 communicates with a monitoring device or controller. Upon installing or engaging the cartridge 214 with the connector head 216, the relative rotation of the bar codes (e.g., bar code 220a) with respect to the scanner 222 causes the performance set point data represented by the bar code to be transmitted to the monitoring device for comparison with sensed performance parameters obtained by the monitoring device.

In an alternate embodiment of the invention, the bar codes 220a, 220b may simply provide the monitoring device or controller with identification data in the form of a graphical signature that causes the monitoring device to access stored cartridge performance set points corresponding to the identified cartridge from a library of stored set points that have been loaded into the monitoring device by the cartridge manufacturer. Furthermore, the monitoring device could be programmed to sound an alarm if the bar code provided on the cartridge does not represent a recognized signature. This would prevent the use of unauthorized and/or incompatible cartridge, so as to maintain the integrity of the fluid treatment system.

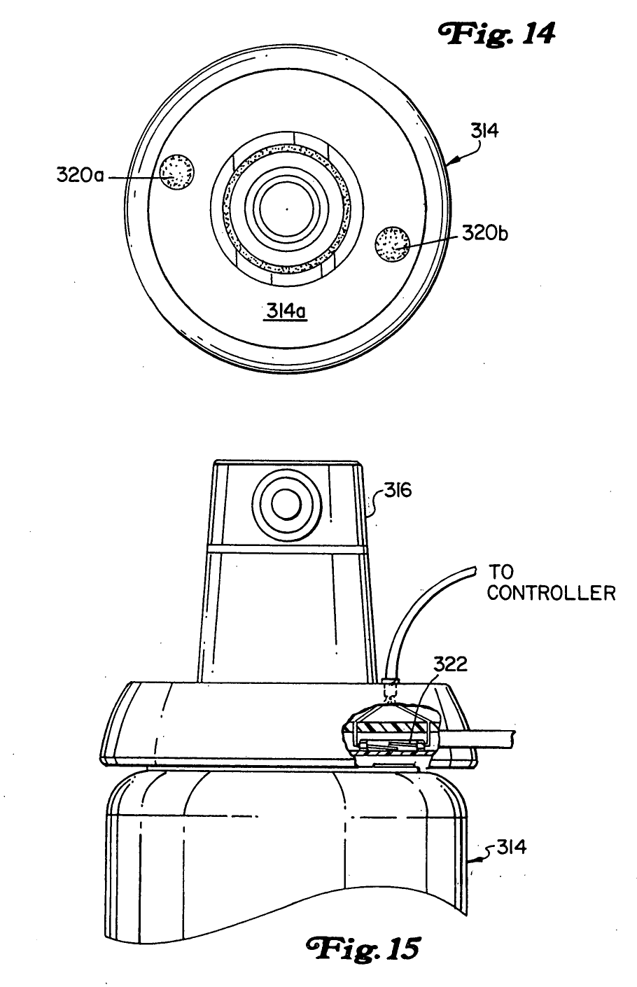

Referring to FIGS. 14 and 15, there is illustrated another fluid treatment cartridge 314 constructed in accordance with a preferred embodiment of the subject invention which includes a static memory storage device in the form of diametrically opposed magnetic field generating devices 320a, 320b. The magnetic field generating devices are positioned on the upper surface 314a of cartridge 314 to interact with at least one reed switch 322 mounted on the under surface of the connector head 316. The reed switch 322 communicates with a monitoring device or controller, and is adapted to close in the presence of a specific magnetic field. Thus, when a compatible cartridge is installed or engaged in the connector head 316, the reed switch 322 will close and the monitor will recognize the cartridge.

The magnetic field generating devices 320a, 320b of cartridge 314 will thereby provide the monitoring device or controller with identification data in the form of a magnetic signature that causes the monitoring device to access stored cartridge performance set points corresponding to the cartridge from a library of stored set points that have been loaded into the memory of the monitoring device by the cartridge manufacturer. As with the bar code feature, the monitoring device 312 could be programmed to sound an alarm if the magnetic field provided on the cartridge does not represent a recognized signature. This would prevent the use of unauthorized and/or incompatible cartridge, so as to maintain the integrity of the fluid treatment system.

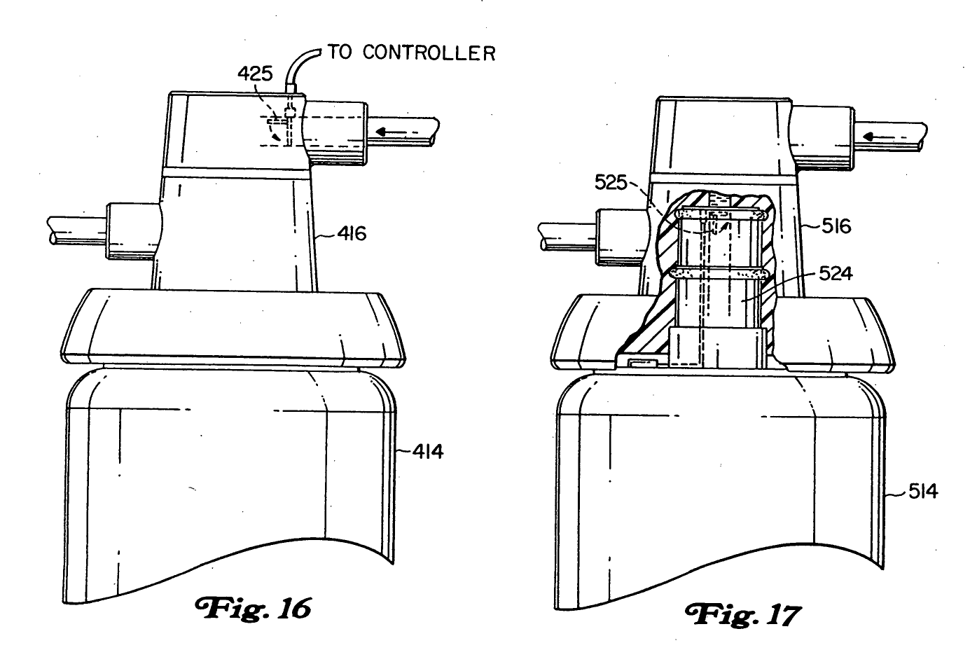

Referring now to FIG. 16, there is illustrated an embodiment of the subject invention which includes a connector head 416 having an electronically controlled valve member 425 for selectively preventing fluid flow through the fluid flow path of the connector head 416. The valve member 425 is operatively associated with a controller in the monitoring device and is adapted and configured to move to a closed position when, for example, the monitoring device determines that a performance set point associated with the cartridge 414 has been exceeded. Alternatively, the valve member 425 may be moved to a closed position to prevent flow through the connector head 416 when the monitoring device determines that the cartridge is incompatible with the fluid treatment system, e.g., it originated from an unauthorized after market supplier. This could happen in the presence of an incorrect bar code or magnetic signature, or in the absence of either of the same when one is expected to be present.

As shown in FIG. 17, an embodiment of subject invention can include a cartridge 514 with an internal electronically controlled valving member 525 for selectively preventing fluid flow through the fluid flow path of the cartridge neck 524. Valve member 525 can be operatively associated with a controller in the monitoring device of the system or with a microprocessor associated with the circuit board embedded on the cartridge. The cartridge based valve member 525 is adapted and configured to move to a closed position to disable the cartridge 514 when a performance set point has been exceeded.

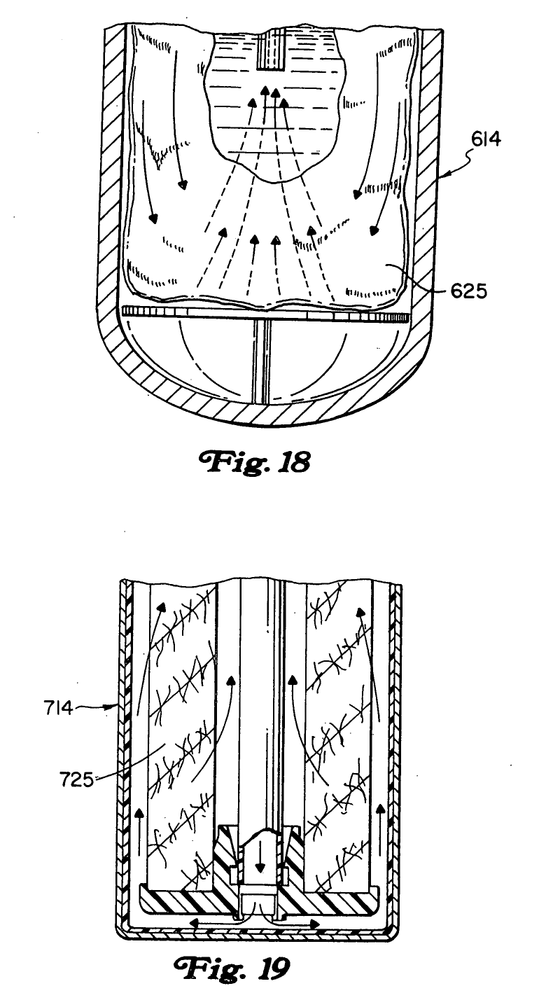

As noted briefly hereinabove, the subject invention is directed to a fluid treatment system. Therefore, the replaceable cartridge may take many forms and is not limited to any particular type of fluid treatment device. For example, as illustrated in FIG. 18, the fluid treatment cartridge can be in the form of an additive dispensing device 614 configured to dispense metered quantities of a liquid additive contained within a bladder 625 into a fluid flow passing through the cartridge. This can be used to treat potable water to improve taste, odor or color for example. An example of a suitable additive dispensing cartridge is disclosed in commonly assigned U.S. Pat. No. 5,919,360 to Contaxis, III et al. the disclosure of which is incorporated herein by reference in its entirety.

The replaceable cartridge of the subject invention can be in the form of a fluid filtering device 714 designed to remove impurities from potable water, as illustrated for example in FIG. 19. In such instances, the filter media 725 can be in the form of a carbon based media, cellulosic fiber media, pleated membrane media, microporous fiber media or combinations thereof. An example of suitable filter element constructed from a combination of a carbon block media and a microporous fiber media is disclosed in commonly assigned U.S. Patent No. U.S. Pat. No. 6,139,739 to Hamlin et al. the disclosure of which is incorporated herein by reference in its entirety. An example of a suitable pleated filter element is disclosed in commonly assigned U.S. Pat. No. 6,315,130 to Olson, the disclosure of which is incorporated herein by reference in its entirety. It is further envisioned that the fluid treatment cartridge of the subject invention can be in the form of a coalecser configured to separate water from hydrocarbons.

Referring now to FIG. 20, there is illustrated a fluid treatment system constructed in accordance with a preferred embodiment of the subject invention and designated generally by reference numeral 800 wherein the connector head 816 communicates with a monitoring device 812 by way of wireless communication. In such an environment, the monitoring device 812 can be situated in a remote location and operatively associated with a computer terminal 825 that would enable an operator to download cartridge performance data from the connector head 816 as well as upload information to the cartridge 814 for storage on an embedded memory storage device associated therewith.

Although the disclosed fluid treatment system has been described with respect to preferred embodiments, it is apparent that modifications and changes can be made thereto without departing from the spirit and scope of the invention as defined by the appended claims.

What is claimed is:

1. A fluid treatment system comprising:
a) a fluid treatment cartridge for treating fluid passing therethrough, the cartridge having an inlet through which untreated fluid enters the cartridge and an outlet from which treated fluid exits the cartridge, the cartridge including means for storing data; and
b) means for facilitating an exchange of data between the fluid treatment cartridge and a cartridge monitoring device.

2. A fluid treatment system as recited in claim 1, further comprising a cartridge monitoring device adapted and configured to receive and process data from the fluid treatment cartridge.

3. A fluid treatment system as recited in claim 1, wherein the monitoring device includes means for comparing cartridge performance parameters received from the sensing means with cartridge set point data stored in the data storing means of the fluid treatment cartridge to determine whether a cartridge set point has been exceeded.

4. A fluid treatment system as recited in claim 1, further comprising a connector head configured to detachably support the fluid treatment cartridge, the connector head having an inlet flow path for directing untreated fluid to the inlet of the cartridge and an outlet flow path for directing treated fluid from the outlet of the cartridge.

5. A fluid treatment system comprising:
a) a fluid treatment cartridge for treating fluid passing therethrough, the cartridge having an inlet through which untreated fluid enters the cartridge and an outlet from which treated fluid exits the cartridge, the cartridge including means for storing data; and
b) a connector head configured to detachably support the replaceable fluid treatment cartridge, the connector head having an inlet flow path for directing untreated fluid to the inlet of the cartridge and an outlet flow path for directing treated fluid from the outlet of the cartridge, the connector head including means for facilitating an exchange of data between the fluid treatment cartridge and a cartridge monitoring device.

6. A fluid treatment system as recited in claim 5, wherein the means for storing data is a dynamic data storage device.

7. A fluid treatment system as recited in claim 5, wherein cartridge identification data is stored in the means for storing data.

8. A fluid treatment system as recited in claim 5, wherein the means for storing data is a static data storage device.

9. A fluid treatment system as recited in claim 5, further comprising means operatively associated with the monitoring means for displaying information relating to cartridge performance.

10. A fluid treatment system comprising:
a) a replaceable fluid treatment cartridge for treating fluid passing therethrough, the cartridge having an inlet through which untreated fluid enters the cartridge and an outlet from which treated fluid exits the cartridge;
b) monitoring means in electrical communication with the fluid treatment cartridge for monitoring data relating to cartridge performance, the monitoring means including:
i) means for storing performance set point data;
ii) means for receiving cartridge performance data;
iii) means for comparing the cartridge performance data to the performance set point data to determine whether a set point has been exceeded; and
c) means for terminating the electrical connection between the fluid treatment cartridge and the monitoring means when a set point has been exceeded, so as to encourage replacement of the fluid treatment cartridge.

11. A fluid treatment system as recited in claim 10, wherein the means for terminating the electrical connection between the fluid treatment cartridge and the monitoring means is a fuse.

12. A fluid treatment system as recited in claim 10, further comprising sensing means operatively associated with the monitoring means for measuring parameters relating to the performance of the fluid treatment cartridge.

13. A fluid treatment cartridge comprising:
a) a cartridge housing defining an interior chamber housing a fluid treatment device for treating fluid passing through the cartridge, the cartridge housing having an inlet through which untreated fluid enters the interior chamber of the housing and an outlet from which treated fluid exits the interior chamber of the cartridge housing, and
b) means associated with the cartridge housing for storing data.

14. A fluid treatment cartridge as recited in claim 13, wherein the means for storing data includes data relating to cartridge performance.

15. A fluid treatment cartridge as recited in claim 13, wherein the means for storing data includes data relating to cartridge identification.

16. A fluid treatment cartridge as recited in claim 13, wherein the means for storing data includes data relating to cartridge specifications.

17. A fluid treatment cartridge as recited in claim 13, wherein the means for storing data includes data relating to product offerings.
